(19) United States
(12) Patent Application Publication
(10) Pub. No.: US 2026/0112213 A1
(43) Pub. Date: Apr. 23, 2026

(54) DETERMINATION APPARATUS

(71) Applicant: ISUZU MOTORS LIMITED, Yokohama-shi (JP)

(72) Inventor: Tomoaki HIROSAWA, Fujisawa-shi (JP)

(21) Appl. No.: 19/356,760

(22) Filed: Oct. 13, 2025

(30) Foreign Application Priority Data
Oct. 21, 2024 (JP) 2024-185380

(51) Int. Cl. G07C 5/04; B60L 50/75

(52) U.S. Cl. CPC G07C 5/04; B60L 50/75; B60L 2240/26; B60L 2240/54; B60L 2240/645; B60L 2240/66

(57) ABSTRACT

A determination apparatus acquires i) a road condition of a route along which a vehicle, driven by electric power from a fuel cell and a secondary battery, is planned to travel, and ii) a weight of the vehicle at a current position. The determination apparatus i) identifies a rolling resistance coefficient corresponding to the acquired road condition by referring to a data table in which each of a plurality of road conditions is associated with a rolling resistance coefficient when wheels of the vehicle roll on the road having the road condition, and ii) determines electrical energy required for the vehicle to travel along the route by using a rolling resistance determined by a product of the identified rolling resistance coefficient and the acquired weight.

### CROSS-REFERENCE TO RELATED APPLICATIONS

The present application claims priority to Japanese Patent Applications No. 2024-185380, filed on Oct. 21, 2024, contents of which are incorporated herein by reference in their entirety.

### BACKGROUND OF THE INVENTION

The present disclosure relates to a determination apparatus that determines energy required for a vehicle to travel along a planned route. A technique is known for calculating energy required for a vehicle to travel along a travel route, which extends from a current location to a destination. Japanese Unexamined Patent Application Publication No. 2016-049922 discloses a technique for calculating a rolling resistance coefficient of a road along which a vehicle has traveled, based on energy consumption actually measured when the vehicle traveled along the road under a specific condition at an arbitrary location, and determining energy required for the vehicle to travel along a road along which the vehicle is planned to travel, using the calculated rolling resistance coefficient.

However, since a road condition changes, the rolling resistance coefficient of the road along which the vehicle has traveled may differ from the rolling resistance coefficient of the road along which the vehicle is planned to travel. Accordingly, there may be a case where the determined required energy and the actual energy consumption when the vehicle has traveled along the road differ from each other.

### BRIEF SUMMARY OF THE INVENTION

The present disclosure focuses on this point, and an object thereof is to appropriately determine energy required for a vehicle to travel along a road.

An aspect of the present disclosure provides a determination apparatus that includes an acquisition unit that acquires i) a planned route along which a vehicle, driven by power from a motor operating on electric power from a fuel cell and a secondary battery, is to travel from a current position of the vehicle to a target position located a predetermined distance ahead, ii) a road condition of the route, and iii) a weight of the vehicle at the current position, an identification unit that identifies a rolling resistance coefficient corresponding to the acquired road condition by referring to a data table that associates each of a plurality of road conditions with a rolling resistance coefficient when wheels of the vehicle roll on a road having the road condition, and a determination unit that determines electrical energy required for the vehicle to travel along the route by using a rolling resistance determined by a product of the identified rolling resistance coefficient and the acquired weight.

### BRIEF DESCRIPTION OF THE DRAWINGS

FIG. 1 shows an overview of a vehicle according to the present embodiment.

FIG. 2 illustrates a configuration of a determination apparatus.

FIG. 3 is an example of a data table in which road conditions are associated with rolling resistance coefficients.

FIG. 4 illustrates a process for determining required electric power for a new route.

FIG. 5 is a flowchart showing an example of a process for determining required electric power.

FIG. 6 is a flowchart showing an example of a vehicle weight identifying process.

FIG. 7 is a flowchart showing an example of a rolling resistance identifying process.

### DETAILED DESCRIPTION OF THE INVENTION

Hereinafter, the present disclosure will be described through exemplary embodiments, but the following exemplary embodiments do not limit the invention according to the claims, and not all of the combinations of features described in the exemplary embodiments are necessarily essential to the solution means of the invention.

### [Overview of Vehicle 100]

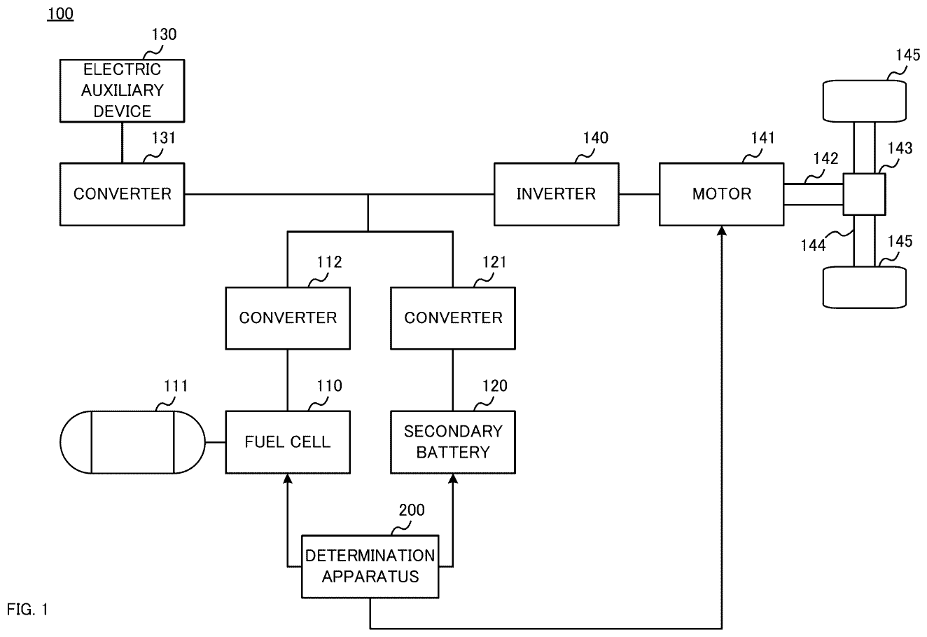

FIG. 1 shows an overview of a vehicle 100 according to the present embodiment. The vehicle 100 includes a fuel cell 110, a hydrogen tank 111, a converter 112, a secondary battery 120, a converter 121, an electric auxiliary device 130, a converter 131, an inverter 140, a motor 141, wheels 145, and a determination apparatus 200. The vehicle 100 is an electric vehicle that travels by a motor 141 operating on electric power from the fuel cell 110 and the secondary battery 120. The vehicle 100 is a truck that carries cargo, for example, but is not limited thereto. The vehicle 100 has a function of determining electric energy required to operate the motor 141 when the vehicle 100 travels along a predetermined route, and determining outputs of the fuel cell 110 and the secondary battery 120 based on the determined required electric power. In the following, the electric energy required to operate the motor 141 is referred to as required electric power.

The fuel cell 110 generates electricity by using a chemical reaction between fuel and an oxidizing agent. The fuel cell 110 generates electricity by causing hydrogen serving as fuel to react with oxygen as an oxidizer, for example. Hydrogen stored in the hydrogen tank 111 connected to the fuel cell 110 is supplied to the fuel cell 110. Oxygen in the air taken in from an intake port (not shown in figures) is supplied to the fuel cell 110. The fuel cell 110 supplies electricity (electric power) generated by causing hydrogen to react with oxygen, to the motor 141 and the electric auxiliary device 130. Specifically, the fuel cell 110 supplies electric power to the motor 141 and the electric auxiliary device 130 via the converter 112.

The converter 112 is provided between a) the fuel cell 110 and b) the motor 141 and the electric auxiliary device 130. The converter 112 is a circuit that converts voltage of direct current output from the fuel cell 110 into voltage that can be used by the motor 141 and the electric auxiliary device 130. Specifically, the converter 112 i) boosts the voltage of the direct current output from the fuel cell 110 and ii) supplies the boosted voltage to the motor 141 and the electric auxiliary device 130.

The secondary battery 120 is a battery capable of charging and discharging electric power. The secondary battery 120 is a lithium ion battery or a lead acid battery, for example, but is not limited thereto, and a known secondary battery can be used. The secondary battery 120 stores electric power by receiving regenerative electric power from the motor 141 and electric power output from the fuel cell 110. The secondary battery 120 supplies electric power to the motor 141 and the electric auxiliary device 130 by discharging the stored electric power. Specifically, the secondary battery 120 supplies electric power to the motor 141 and the electric auxiliary device 130 via the converter 121.

The converter 121 is provided between a) the secondary battery 120 and b) the motor 141 and the electric auxiliary device 130. The converter 121 is a circuit that converts voltage of direct current output from the secondary battery 120 into voltage that can be used by the motor 141 and the electric auxiliary device 130. Specifically, the converter 121 i) boosts the voltage of the direct current output from the secondary battery 120 and ii) supplies the boosted voltage to the motor 141 and the electric auxiliary device 130.

The electric auxiliary device 130 is a device that is mounted on the vehicle 100 and operates on electric power. The electric auxiliary device 130 is an air conditioner, a light, a measuring device, and a display device, for example, but is not limited thereto, and includes a device that is mounted on the vehicle 100 and operates on electric power. The electric auxiliary device 130 is connected to the fuel cell 110 and the secondary battery 120 via the converter 131. The converter 131 converts voltage of direct current supplied from at least one of the fuel cell 110 or the secondary battery 120 into voltage that can be used by the electric auxiliary device 130.

The inverter 140 is provided between a) the converter 112 and the converter 121 and b) the motor 141. The inverter 140 is a circuit that converts direct current into alternating current or converts alternating current into direct current. The inverter 140 converts the direct current supplied from the fuel cell 110 via the converter 112 and the direct current supplied from the secondary battery 120 via the converter 121 into alternating current that can be used by the motor 141. Further, when the motor 141 functions as a generator, the inverter 140 converts alternating current generated by the motor 141 into direct current and supplies the direct current to the secondary battery 120 via the converter 121.

The motor 141 operates on electric power from the fuel cell 110 and the secondary battery 120. The motor 141 operates when supplied with the electric power from at least one of the fuel cell 110 or the secondary battery 120, and causes the vehicle 100 to travel. Specifically, the motor 141 rotates an axle 144 via a differential gear 143 connected to an output shaft 142 of the motor 141. When the axle 144 rotates, the wheels 145 connected to the axle 144 rotate, and the vehicle 100 travels.

The determination apparatus 200 determines the required electric power to operate the motor 141 when the vehicle 100 travels along a predetermined route. Specifically, the determination apparatus 200 determines the required electric power for the vehicle 100 to travel along a planned route using a rolling resistance based on i) a rolling resistance coefficient corresponding to road condition of a route along which the vehicle 100 is planned to travel and ii) weight of the vehicle 100. The determination apparatus 200 can appropriately determine the required electric power by using an appropriate rolling resistance coefficient corresponding to the condition of the road to be traveled, and can therefore appropriately determine output allocation between the fuel cell and the secondary battery.

### [Configuration of Determination Apparatus 200]

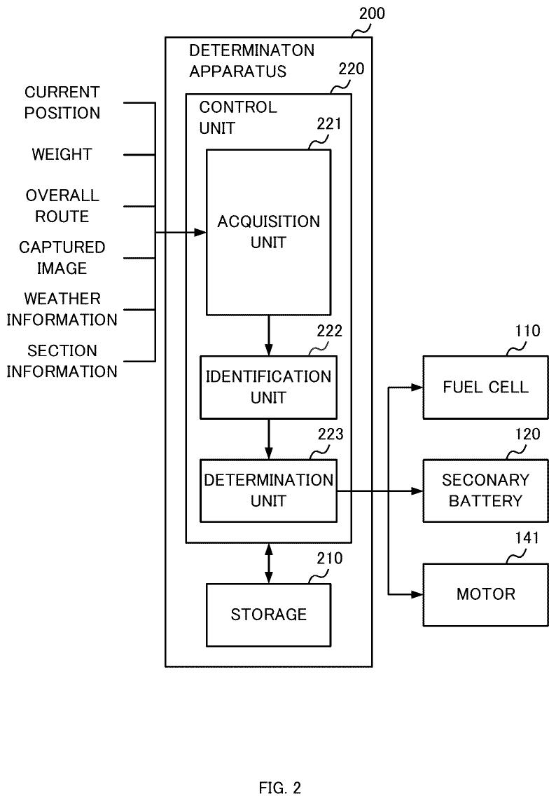

FIG. 2 illustrates a configuration of the determination apparatus 200. The determination apparatus 200 includes a storage 210 and a control unit 220. The storage 210 is a storage medium including a Read Only Memory (ROM), a Random Access Memory (RAM), a hard disk, and the like. The storage 210 stores a program executed by the control unit 220.

The control unit 220 is a calculation resource including a processor such as a Central Processing Unit (CPU). The control unit 220 implements functions of an acquisition unit 221, an identification unit 222, and a determination unit 223 by executing the program stored in the storage 210.

The acquisition unit 221 acquires a current position of the vehicle 100. The acquisition unit 221 acquires the current position of the vehicle 100 identified by a Global Positioning System (GPS) receiver mounted on the vehicle 100. The GPS receiver receives radio waves transmitted from GPS satellites and identifies coordinates indicating the current position of the vehicle 100.

The acquisition unit 221 acquires the weight of the vehicle 100 at the current position. For example, the acquisition unit 221 acquires the weight of the vehicle 100 based on i) a strain of a suspension connecting a vehicle body of the vehicle 100 and the axle 144 and ii) an air pressure of the suspension, when acquiring the current position. The acquisition unit 221 may acquire the weight of the vehicle 100 based on an acceleration of the vehicle 100 during traveling. It should be noted that a method for acquiring the weight of the vehicle 100 is not limited thereto, and a known technique can be used.

The acquisition unit 221 acquires the route along which the vehicle 100 is planned to travel. Specifically, the acquisition unit 221 acquires, from a management device, an overall route including a plurality of route points, the overall route being a planned route along which the vehicle 100 is to travel from a departure point to a destination. The management device is a server operated by a company that manages the vehicle 100, and stores the overall route along which the vehicle 100 equipped with the determination apparatus 200 is to travel. The acquisition unit 221 acquires the overall route from the management device via wireless communication using a wireless communication module not shown in figures.

The acquisition unit 221 acquires a partial route of the overall route. The acquisition unit 221 acquires, as a part of the overall route, a partial route extending from the current position of the vehicle 100 to a target position located a predetermined distance ahead. The predetermined distance is shorter than the overall route. As a specific example, the predetermined distance is 20 kilometers, but is not limited thereto. It should be noted that the acquisition unit 221 may not only extract the partial route from the previously acquired overall route, but may also acquire only the partial route of the overall route from the management device. In the following description, the partial route of the overall route is referred to as a predicted section.

The acquisition unit 221 acquires road condition in the predicted section. The acquisition unit 221 acquires which of a plurality of road conditions applies to a road of the predicted section ahead in the traveling direction of the vehicle 100, by analyzing a captured image obtained by capturing the road of the predicted section. The plurality of road conditions include a dry condition, a wet condition, a puddle condition, a snow-covered condition, and an icy condition, for example, but are not limited thereto. The captured image is an image captured by an imaging device mounted on the vehicle 100 or an imaging device installed on the road of the predicted section. When acquiring a captured image from the imaging device installed on the road of the predicted section, the acquisition unit 221 acquires a captured image captured by the imaging device via wireless communication using the wireless communication module.

The acquisition unit 221 acquires weather conditions in the predicted section. Specifically, the acquisition unit 221 acquires weather information indicating weather conditions in a region including the predicted section from a server that provides the weather information via wireless communication using the wireless communication module. The weather includes clear, cloudy, rainy, or snowy conditions, for example, but is not limited thereto. Further, the acquisition unit 221 acquires weather information, including an amount of rainfall or snowfall per unit time in the region including the road of the predicted section, from the server.

The acquisition unit 221 acquires section information on the predicted section. The section information includes a road gradient, a road curvature, a speed limit, and vehicle speeds of other vehicles 100 traveling on the road of the predicted section (i.e., traffic flow speed). For example, the acquisition unit 221 acquires the section information including the road gradient, the road curvature, the speed limit, and the traffic flow speed of the road of the predicted section via wireless communication from a server operated by a provider managing the road of the predicted section.

The acquisition unit 221 calculates a predicted speed of the vehicle 100 in the predicted section based on the acquired section information. The acquisition unit 221 calculates the predicted speed of the vehicle 100 in the predicted section based on the road gradient, the road curvature, the speed limit, and the traffic flow speed indicated by the section information. The predicted speed is a speed equal to or lower than the speed limit, and is a speed at which the vehicle 100 can travel the predicted section, in accordance with the traffic flow speed, without deviating from a lane of the road having the road gradient and the road curvature. A known technique can be used as a method for calculating the predicted speed.

The identification unit 222 identifies the rolling resistance coefficient corresponding to the road condition in the predicted section. For example, the identification unit 222 identifies the rolling resistance coefficient corresponding to the acquired road condition by referring to a data table in which each of a plurality of road conditions is associated with the rolling resistance coefficient when the wheels 145 of the vehicle 100 roll on the road having the road condition. The data table is stored in the storage 210.

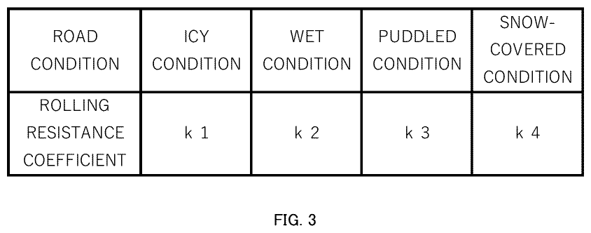

FIG. 3 is an example of the data table in which the road conditions are associated with the rolling resistance coefficients. The more resistant the wheels 145 of the vehicle 100 are to rolling, the higher the rolling resistance coefficient is. For example, a rolling resistance coefficient k3 for a puddled road condition and a rolling resistance coefficient k4 for a snow-covered road condition are larger than a rolling resistance coefficient k1 for an icy road condition and a rolling resistance coefficient k2 for a wet road condition. When snow is accumulated on the road, the wheels 145 are more resistant to rolling than when there are puddles on the road, and so the rolling resistance coefficient k4 for a snow-covered road condition is larger than the rolling resistance coefficient k3 for a puddled road condition. When the road is frozen, the wheels 145 roll more easily than when the road is wet, and so the rolling resistance coefficient k1 for an icy road condition is smaller than the rolling resistance coefficient k2 for a wet road condition.

The identification unit 222 identifies the rolling resistance coefficient according to the weather conditions in the predicted section. For example, when the weather condition in the predicted section, as indicated by the weather information, is neither clear nor cloudy, i.e., when it is rainy or snowy, the identification unit 222 identifies the rolling resistance coefficient corresponding to the road condition in the predicted section by referring to the data table shown in FIG. 3.

When the weather in the predicted section is clear or cloudy, the identification unit 222 identifies an initial value of the rolling resistance coefficient as the rolling resistance coefficient of the road in the route. The initial value of the rolling resistance coefficient is a rolling resistance coefficient when the road is in a dry state, for example. Specifically, the initial value of the rolling resistance coefficient is a rolling resistance coefficient between the wheel 145 and a dry asphalt-paved road, but is not limited thereto. When the weather in the predicted section is clear or cloudy, the identification unit 222 can reduce a processing load for identifying the rolling resistance coefficient by using the initial value of the rolling resistance coefficient.

The identification unit 222 identifies the rolling resistance coefficient using a correction value corresponding to the weather conditions in the predicted section. For example, the identification unit 222 identifies the rolling resistance coefficient based on the correction value for the rolling resistance coefficient according to an amount of rainfall or snowfall. Specifically, the greater the amount of rainfall, the more likely deeper puddles are to form, and thus the identification unit 222 identifies a greater rolling resistance coefficient as the amount of rainfall increases. Similarly, it is considered that the rolling resistance coefficient increases as the amount of snowfall increases, and thus the identification unit 222 identifies a greater rolling resistance coefficient as the amount of snowfall increases.

The identification unit 222 identifies a correction value corresponding to the weather conditions by referring to a data table that associates each of a plurality of weather conditions (light rainfall, heavy rainfall, light snowfall, and heavy snowfall) with the correction value for the rolling resistance coefficient. For example, the identification unit 222 refers to a rainfall data table that associates each of a plurality of rainfall amounts with a correction value for the rolling resistance coefficient corresponding to each rainfall amount, and identifies the correction value for the rolling resistance coefficient corresponding to the acquired rainfall amount. The rainfall data table is stored in the storage 210, for example. In the rainfall data table, each of the plurality of rainfall amounts is associated with a correction value for the rolling resistance coefficient, such that a larger rainfall amount is associated with a higher correction value.

Similarly, the identification unit 222 refers to a snowfall data table that associates each of a plurality of snowfall amounts with a correction value for the rolling resistance coefficient corresponding to the snowfall amount, and identifies the correction value for the rolling resistance coefficient corresponding to the acquired snowfall amount. The snowfall data table is stored in the storage 210, for example. In the snowfall data table, each of the plurality of snowfall amounts is associated with a correction value for the rolling resistance coefficient, such that a larger snowfall amount is associated with a higher correction value. The identification unit 222 identifies the correction value for the rolling resistance coefficient corresponding to the rainfall amount or snowfall amount, and then identifies a product of a reference value of the rolling resistance coefficient and the identified correction value as the rolling resistance coefficient.

After identifying the rolling resistance coefficient, the identification unit 222 identifies the rolling resistance when the vehicle 100 travels along the predicted section. When the weight of the vehicle 100 at the current position has been acquired, the identification unit 222 identifies a product of the identified rolling resistance coefficient and the acquired weight of the vehicle 100 as the rolling resistance in the predicted section. When the weight of the vehicle 100 at the current position has not been acquired, the identification unit 222 identifies a product of the identified rolling resistance coefficient and a value set as an initial value of the weight of the vehicle 100 as the rolling resistance in the predicted section. The initial value of the weight of the vehicle 100 is determined based on a maximum loading capacity of the vehicle 100, for example. A specific example of the initial value of the weight of the vehicle 100 is a sum of the weight of the vehicle 100 in a state equipped with equipment required for operation and one-half of the maximum loading capacity indicating the maximum mass of a cargo that can be loaded onto the vehicle 100, but is not limited thereto.

The determination unit 223 uses the identified rolling resistance to determine the required electric power for the vehicle 100 to travel along the route. The determination unit 223 determines output electric power P required per unit time for traveling the predicted section by inputting the identified rolling resistance to the following Equation (1). In the following Equation (1), a product of a rolling resistance coefficient r_{Roll} and a vehicle mass M represents the rolling resistance.

$$[ Formula 1 ]$$

$$P = \text{} ( \frac{1}{η \cdot ϵ} ) \cdot \text{} u \cdot \text{} \{ g \cdot {r}_{Roll} \cdot M + \text{} \frac{1}{2} ρ \cdot {C}_{d} \cdot S \cdot {u}^{2} + g \cdot M \cdot sin θ + a ( 1 + {k}_{Rotar} ) \cdot M \} \qquad ( 1 )$$

Each variable in the Equation (1) will be described. u represents a speed (m/s) of the vehicle 100. a represents an acceleration (m/s²) of the vehicle 100. M represents the weight (kg) of the vehicle 100. η represents a transmission efficiency of a drive system of the vehicle 100. ε represents an efficiency (power) of the motor 141 and the controller. r_{Roll} represents the rolling resistance coefficient. Ca represents an air resistance coefficient. ρ represents an air density (kg/m³). S represents a front-projected area (m²) of the vehicle 100. k_{Rotar} represents an equivalent rotational inertia coefficient. θ in sin θ represents a gradient of the road in the traveling direction of the vehicle 100 along the route.

The determination unit 223 determines required electric power W by integrating the output electric power P with time. Specifically, the determination unit 223 a) determines the required electric power W to be supplied to the motor 141 by calculating a following Equation (2) when P>0, and b) determines regenerative electric power generated by the motor 141 as the required electric power W by calculating the following Equation (3) when P<0. φ in Equation (3) is a regeneration rate (%) when the motor 141 generates the regenerative electric power.

$$[ Formula 2 ]$$

$$W = \int Pdt P > 0 \qquad ( 2 )$$

$$W = \int Pdt \cdot ϕ P < 0 \qquad ( 3 )$$

The determination unit 223 determines the output allocation between the fuel cell 110 and the secondary battery 120 by using the determined required electric power W and regenerative power. Specifically, the determination unit 223 determines the output allocation between the fuel cell 110 and the secondary battery 120 so that the fuel consumption for outputting the required electric power W is minimized, by using the equivalent cost minimization method. More specifically, the determination unit 223 i) determines an equivalent cost coefficient to minimize the fuel consumption and to reduce the difference in state of charge between the departure point and the destination of the route, and ii) determines the output allocation between the fuel cell 110 and the secondary battery 120 based on the determined coefficient. It should be noted that the method for allocating the output of the fuel cell 110 and the output of the secondary battery 120 is not limited to the equivalent cost minimization method, and a known technique can be used.

The determination unit 223 can determine an appropriate output power P based on the rolling resistance coefficient of the road along which the vehicle 100 is planned to travel and the weight of the vehicle 100 at the current position. Thus, the determination unit 223 can appropriately allocate the output of the fuel cell 110 and the output of the secondary battery 120 so that the fuel consumption is minimized. As a result, the determination unit 223 can make the output current of the fuel cell 110 substantially constant and reduce the difference between the state of charge at the departure point and the state of charge at the destination of the route.

### (Process for Determining Required Electric Power for New Route)

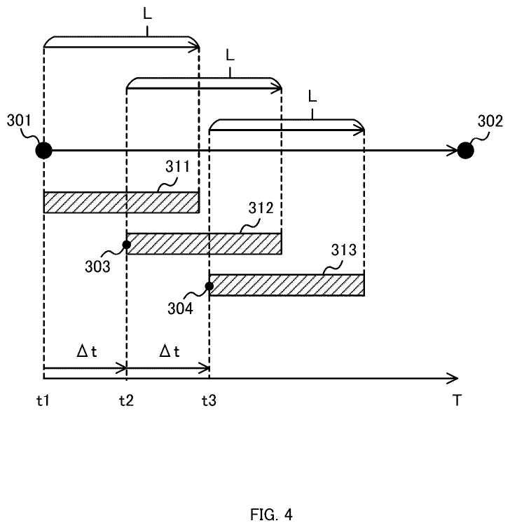

While the vehicle 100 is traveling in the predicted section, the determination apparatus 200 determines the required electric power for a new route, in order to more appropriately determine the output allocation between the fuel cell 110 and the secondary battery 120. In the following, a process for determining the required electric power for a new route will be described with reference to FIG. 4. FIG. 4 illustrates the process for determining the required electric power for a new route. The acquisition unit 221 acquires the overall route, which extends from a departure point 301 of the vehicle 100 to a destination 302. The current position of the vehicle 100 at time t1 is the departure point 301. At the time t1, the vehicle 100 starts traveling from the departure point 301 toward the destination 302.

The acquisition unit 221 acquires i) the road condition in the predicted section 311 of the overall route, the section extending from the current position of the vehicle 100 at the time t1 (departure point 301) to a target position located a predetermined distance L ahead, and ii) the weight of the vehicle 100 at the time t1. The identification unit 222 identifies the rolling resistance coefficient corresponding to the condition in the predicted section 311. The determination unit 223 determines the output power P at each of a plurality of route points included in the predicted section 311 by inputting, into Equation (1), the rolling resistance, which is determined by the product of the rolling resistance coefficient and the weight of the vehicle 100. The determination unit 223 determines the required electric power W as the total of a plurality of output powers P.

The vehicle 100 travels along the predicted section 311 for a predetermined time Δt from the time t1. While the vehicle 100 is traveling in the predicted section 311 for which the required electric power has been determined, the acquisition unit 221 acquires a new predicted section that extends, from the current position of the vehicle 100, the predetermined distance L ahead. Specifically, when the predetermined time Δt has elapsed while the vehicle 100 is traveling the predicted section 311 and time t2 is reached, the acquisition unit 221 acquires a new predicted section 312 that extends from the current position 303 of the vehicle 100 at the time t2 to a target position located the predetermined distance L ahead within the overall route. The predetermined time is one minute, for example, but is not limited thereto.

After the new predicted section 312 is determined, the acquisition unit 221 acquires the road condition in the new predicted section 312. Further, the acquisition unit 221 acquires the weight of the vehicle 100 at the time t2.

After the road condition in the predicted section 312 is acquired, the identification unit 222 identifies the rolling resistance coefficient corresponding to the road condition in the predicted section 312. The identification unit 222 identifies, as the rolling resistance of the vehicle 100 in the predicted section 312, a product of the rolling resistance coefficient corresponding to the road condition in the predicted section 312 and the weight of the vehicle 100 at the time t2. The determination unit 223 determines the required electric power for the predicted section 312 by using the rolling resistance of the new predicted section 312.

When the predetermined time Δt has elapsed from the time t2 and time t3 is reached, the acquisition unit 221 acquires a new predicted section again. The acquisition unit 221 acquires a new predicted section 313 that extends from the current position 304 of the vehicle 100 at the time t3 to the target position located the predetermined distance L ahead. The acquisition unit 221 acquires the road condition of the new predicted section 313. The identification unit 222 identifies a rolling resistance coefficient of the predicted section 313 based on the road condition of the new predicted section 313. The determination unit 223 determines the required electric power for the predicted section 313 based on the rolling resistance coefficient of the new predicted section 313 and the weight of the vehicle 100.

As described above, the determination apparatus 200 determines the required electric power for the predicted section, which extends from the current position of the vehicle to the target position located the predetermined distance L ahead, at every predetermined time interval Δt. The determination apparatus 200 performs the process for determining the required electric power at every predetermined time interval Δt until the vehicle 100 arrives at the destination 302 or the vehicle 100 stops. Accordingly, the determination apparatus 200 can appropriately identify the rolling resistance coefficient using a latest road condition in the predicted section along which the vehicle is to travel. As a result, the determination apparatus 200 can appropriately identify the required electric power for traveling the predicted section to be traveled. In addition, since the determination apparatus 200 determines the required electric power only for a partial region, that is the predicted section, out of the overall route, calculation resources can be reduced compared to determining the required electric power for traveling the overall route.

### [Process for Determining Required Electric Power]

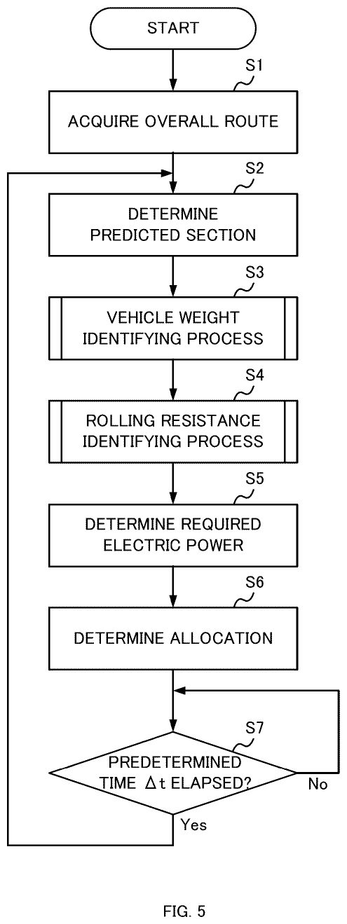

FIG. 5 is a flowchart showing an example of the process for determining the required electric power. The process for determining the required electric power is executed when the vehicle 100 is started. The acquisition unit 221 is assumed to be able to acquire the current position of the vehicle 100 after the vehicle 100 is started.

The acquisition unit 221 acquires the overall route along which the vehicle 100 is planned to travel (step S1). Specifically, the acquisition unit 221 acquires the overall route from the management device that manages the operation of the vehicle 100. The acquisition unit 221 determines a new predicted section that extends from the current position of the vehicle 100 to the position located the predetermined distance L ahead, within the overall route (step S2).

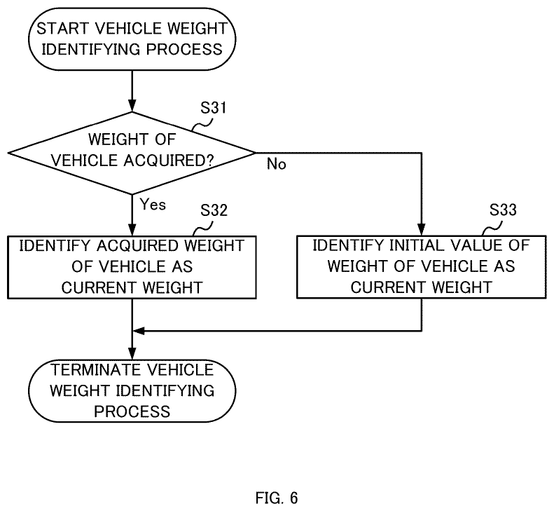

The identification unit 222 executes a vehicle weight identifying process (step S3). FIG. 6 is a flowchart showing an example of the vehicle weight identifying process. The identification unit 222 determines whether or not the weight of the vehicle 100 has been acquired (step S31). If the weight of the vehicle 100 at the current position has been acquired (Yes in step S31), the identification unit 222 identifies the acquired weight of the vehicle 100 as the current weight of the vehicle 100 (step S32). If the weight of the vehicle 100 at the current position has not been acquired (No in step S31), the identification unit 222 identifies the initial value of the weight of the vehicle 100 as the current weight of the vehicle 100 (step S33). After identifying the weight of the vehicle 100, the identification unit 222 terminates the vehicle weight identifying process.

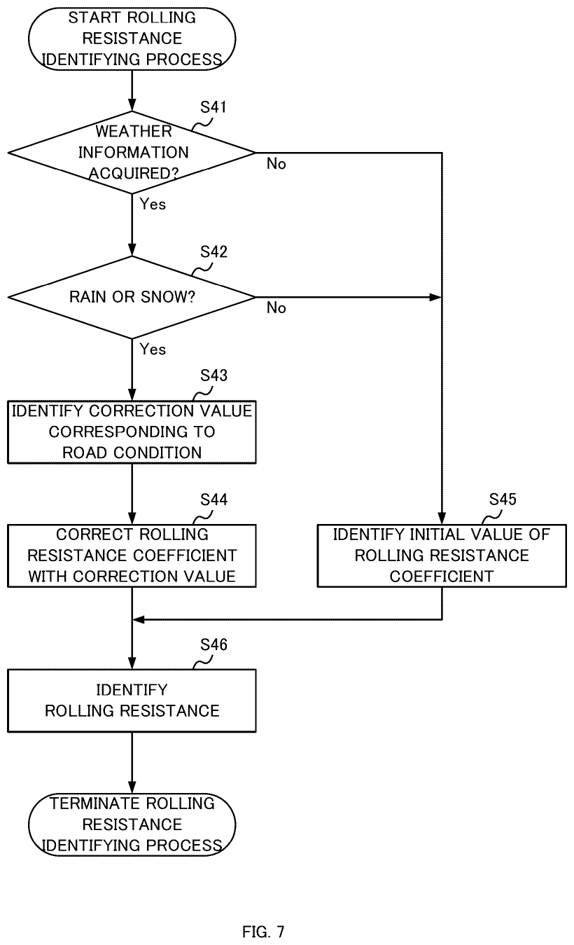

After terminating the vehicle weight identifying process, the identification unit 222 executes a rolling resistance identifying process (step S4). FIG. 7 is a flowchart showing an example of the rolling resistance identifying process. The identification unit 222 determines whether or not the acquisition unit 221 has acquired the weather information of the region including the predicted section (step S41).

If the acquisition unit 221 has acquired the weather information of the region including the predicted section (Yes in step S41), the identification unit 222 determines whether the weather condition indicated by the weather information is rain or snow (step S42). If the weather condition indicated by the weather information is rain or snow (Yes in step S42), the identification unit 222 identifies the correction value corresponding to the road condition (step S43). Specifically, the identification unit 222 identifies the correction value corresponding to the road condition in the predicted section by referring to the data table that associates each of the plurality of road conditions with the correction value.

After identifying the correction value, the identification unit 222 corrects the rolling resistance coefficient with the correction value (step S44). Specifically, the identification unit 222 identifies the product of the initial value of the rolling resistance coefficient and the identified correction value as the rolling resistance coefficient corresponding to the road condition in the predicted section.

If the weather information has not been acquired (No in step S41) or when the weather condition indicated by the weather information is clear or cloudy (No in step S42), the identification unit 222 identifies the initial value of the rolling resistance coefficient as the rolling resistance coefficient of the road of the predicted section (step S45).

After identifying the rolling resistance coefficient, the identification unit 222 identifies the rolling resistance (step S46). Specifically, the identification unit 222 identifies the product of the identified rolling resistance coefficient and the weight of the vehicle 100 as the rolling resistance. The identification unit 222 terminates the rolling resistance identifying process when the rolling resistance is identified.

After the rolling resistance is identified, the determination unit 223 determines the required electric power for the vehicle 100 to travel the predicted section by using the identified rolling resistance (step S5). Specifically, the determination unit 223 determines the required electric power by inputting the rolling resistance to Equation (1).

The determination unit 223 determines the output allocation between the fuel cell 110 and the secondary battery 120 based on the required electric power (step S6). Specifically, the determination unit 223 uses the equivalent cost minimization method to determine the output allocation between the fuel cell 110 and the secondary battery 120, so as to minimize the fuel consumption for generating the required electric power.

The acquisition unit 221 determines whether or not the predetermined time Δt has elapsed after the determination unit 223 determines the output allocation between the fuel cell 110 and the secondary battery 120 (step S7). Specifically, the acquisition unit 221 determines whether the predetermined time Δt has elapsed from the time at which the determination unit 223 determines the output allocation between the fuel cell 110 and the secondary battery 120. If the predetermined time Δt has not elapsed (No in step S7), the acquisition unit 221 waits until the predetermined time Δt elapses. If the predetermined time Δt has elapsed from the time when the output allocation is determined (Yes in step S7), the acquisition unit 221 returns to step S2.

### Modification 1

The acquisition unit 221 may vary the predetermined distance according to a region including the current position of the vehicle 100. Specifically, the acquisition unit 221 sets a first distance, which is a predetermined distance when the current position of the vehicle 100 is included in an expressway, to be longer than a second distance, which is a predetermined distance when the current position of the vehicle 100 is included in an urban area. As a result, when the vehicle 100 travels on an expressway where the road condition is less likely to change, the determination apparatus 200 can reduce the frequency of determining the required electric power, thereby reducing the load of the process for determining the required electric power. In addition, when the vehicle 100 travels in an urban area where the road condition is more likely to change, the determination apparatus 200 can determine the required electric power more frequently, thereby allowing the required electric power to be determined more accurately.

### Modification 2

The acquisition unit 221 may vary the predetermined time, which is an acquisition interval, in accordance with the predetermined distance. For example, the acquisition unit 221 sets a first acquisition interval for acquiring a new road condition when the current position of the vehicle 100 is on an expressway to be longer than a second acquisition interval for acquiring a new road condition when the current position of the vehicle 100 is in an urban area. As a result, since the determination apparatus 200 reduces the frequency of determining the required electric power while the vehicle 100 is traveling on the expressway, thereby reducing the load of the process for determining the required electric power. In addition, since the determination apparatus 200 increases the frequency of determining the required electric power in the urban area where the road condition is likely to change, thereby appropriately determining the required electric power.

### [Effects of Determination Apparatus 200]

As described above, the determination apparatus 200 acquires i) the road condition in the predicted section, which is a planned route along which the vehicle 100, driven by the motor 141 operating on electric power from the fuel cell 110 and the secondary battery 120, is to travel from the current position to the target position located the predetermined distance ahead and ii) the weight of the vehicle 100 at the current position. The determination apparatus 200 identifies the rolling resistance coefficient corresponding to the acquired road condition by referring to the data table that associates the road conditions with the rolling resistance coefficients. Then, the determination apparatus 200 determines the required electric power for the vehicle 100 to travel along the predetermined route by using the rolling resistance determined by the product of the rolling resistance coefficient and the weight of the vehicle 100.

The determination apparatus 200 can identify the appropriate rolling resistance coefficient corresponding to the latest road condition on which the vehicle is to travel, thereby appropriately determining the required electric power when the vehicle 100 travels on the planned route. When the determination apparatus 200 can appropriately determine the required electric power, the vehicle 100 can appropriately determine the output allocation between the fuel cell 110 and the secondary battery 120.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A determination apparatus comprising:
an acquisition unit that acquires i) a planned route along which a vehicle, driven by power from a motor operating on electric power from a fuel cell and a secondary battery, is to travel from a current position of the vehicle to a target position located a predetermined distance ahead, ii) a road condition of the route, and iii) a weight of the vehicle at the current position;
an identification unit that identifies a rolling resistance coefficient corresponding to the acquired road condition by referring to a data table that associates each of a plurality of road conditions with a rolling resistance coefficient when wheels of the vehicle roll on a road having the road condition; and
a determination unit that determines electrical energy required for the vehicle to travel along the route by using a rolling resistance determined by a product of the identified rolling resistance coefficient and the acquired weight.

2. The determination apparatus according to claim 1, wherein
the acquisition unit acquires a road condition of a new route that extends from the current position of the vehicle to the position located the predetermined distance ahead while the vehicle is traveling on the route for which the electric energy has been determined,
the identification unit identifies a rolling resistance coefficient corresponding to the road condition of the new route, and
the determination unit determines electrical energy required to travel along the new route by using the rolling resistance coefficient of a road in the new route and the weight of the vehicle.

3. The determination apparatus according to claim 2, wherein
the acquisition unit i) determines a new route that extends from a current position of the vehicle to a position located the predetermined distance ahead, when a predetermined time has elapsed while the vehicle is traveling on the route for which the electrical energy has been determined, and ii) acquires a road condition of the determined new route.

4. The determination apparatus according to claim 1, wherein
the identification unit
identifies a value set as an initial value of a rolling resistance coefficient as the rolling resistance coefficient of the road in the route when a weather condition of the road is clear or cloudy, and
identifies a rolling resistance coefficient corresponding to the road condition by referring to the data table when the weather condition of the road is neither clear nor cloudy.

5. The determination apparatus according to claim 1, wherein
the determination unit
determines the electrical energy by using a rolling resistance determined by a product of the identified rolling resistance coefficient and the acquired weight, when the weight of the vehicle at the current position has been acquired, and
determines the electrical energy by using a rolling resistance determined by a product of the identified rolling resistance coefficient and a value set as an initial value of the weight of the vehicle, when the weight of the vehicle at the current position has not been acquired.

6. The determination apparatus according to claim 1, wherein
the identification unit identifies a rolling resistance coefficient greater than rolling resistance coefficients corresponding to a wet road condition and an icy road condition, when the road condition corresponds to a puddled road condition or a snow-covered road condition.

7. The determination apparatus according to claim 1, wherein
the acquisition unit sets a first distance, which is the predetermined distance when the current position of the vehicle is included in an expressway, to be longer than a second distance, which is the predetermined distance when the current position of the vehicle is included in an urban area.

8. The determination apparatus according to claim 1, wherein
the acquisition unit acquires a rainfall amount or a snowfall amount of the planned route, and
the identification unit i) identifies a correction value corresponding to the acquired rainfall amount or snowfall amount by referring to a data table that associates each of a plurality of rainfall amounts or snowfall amounts with a correction value for the rolling resistance coefficient, and ii) identifies a product of a reference value of the rolling resistance coefficient and the identified correction value as the rolling resistance coefficient.

9. The determination apparatus according to claim 5, wherein
when the weight of the vehicle at the current position has not been acquired, the initial value is a sum of the weight of the vehicle in a state equipped with equipment required for operation of the vehicle and one-half of a maximum loading capacity indicating a maximum mass of a cargo that can be loaded onto the vehicle, and
the identification unit
identifies a product of the identified rolling resistance coefficient and the acquired weight of the vehicle as the rolling resistance of the planned route, when the weight of the vehicle at the current position has been acquired, and
identifies a product of the initial value and the identified rolling resistance coefficient as the rolling resistance coefficient.
